(19) United States
(12) Patent Application Publication
(10) Pub. No.: US 2008/0129031 A1
(43) Pub. Date: Jun. 5, 2008

(54) Spray Protection Device

(76) Inventor: Larry A. Nelsen, Newcastle, WA (US)

Correspondence Address: SPECKMAN LAW GROUP PLLC, 1201 THIRD AVENUE, SUITE 330, SEATTLE, WA, 98101, US

(21) Appl. No.: 11/935,243

(22) Filed: Nov. 5, 2007

Related U.S. Application Data
(60) Provisional application No. 60/864,367, filed on Nov. 3, 2006.

(51) Int. Cl. B62D 25/18

(52) U.S. Cl. 280/851

(57) ABSTRACT

A spray prevention device that is attachable in proximity to one or more wheels of a vehicle is provided. The spray prevention device comprises a panel provided with a front face, a top edge and a plurality of randomly or irregularly spaced and sized openings that are adapted to permit air to flow through the device while deflecting substantially all water and roadway debris encountered by the panel. In certain embodiments, each opening has an area of about 1/16 in², and the sum of the areas of the plurality of irregularly spaced and sized openings represents at least about 50% of the surface area of the front face of the panel.

### CROSS REFERENCE TO RELATED APPLICATION

This application claims priority under 35 U.S.C. §119(e) to U.S. Provisional Application No. 60/864,367, filed Nov. 3, 2006.

### FIELD OF INVENTION

This invention relates generally to spray protection devices adapted for use on wheeled vehicles.

### BACKGROUND OF THE INVENTION

Many types of spray protection devices, or mud flaps, have been used for preventing water, mud, rocks, and other roadway debris from being directed rearwardly and sidewardly from a moving wheeled vehicle into the path of following traffic. Typically, mud flaps are substantially rectangular in shape and have a solid deflecting panel. The top edge of a typical mud flap is typically mounted behind a wheel of a vehicle such that the bottom of the mud flap hangs freely near the roadway surface.

While conventional solid mud flaps are effective in deflecting water and roadway debris, they suffer from several disadvantages. First, the solid design of the conventional mud flap prevents air from passing through it, thereby increasing the drag created by the mud flap and decreasing a vehicle's fuel economy. Also, the bottom of a solid mud flap may be displaced rearwardly at high rates of speed, thereby reducing the amount of water and roadway debris the mud flap deflects. Further, the conventional solid mud flap increases the temperature in the area about the vehicle's tire because air is not permitted to flow through the mud flap. In addition, a typical mud flap prevents any water or other roadway debris encountered by the mud flap from passing through the mud flap. As a result, a large proportion of the water and other roadway debris encountered by a conventional solid mud flap is projected off the sides of the mud flap and into the path of other traveling vehicles. The conventional mud flap is also heavy and, therefore, decreases a vehicle's fuel economy and payload capacity.

Several modifications have been made to the conventional solid mud flap to address the disadvantages identified above. For example, mud flaps have been provided with openings to permit some air, water and other debris to pass through the mud flap. U.S. Pat. No. 3,350,114 describes a mud flap having a plurality of flexible flaps adapted to be opened by a stream of water and capable of deflecting the stream downwardly. Absent a stream of water, however, the flexible hinged flaps remain substantially closed over the aperture with which each is associated. As a result, the flexible flaps do little to reduce the drag created by the mud flap, the weight of the mud flap, the rearward displacement of the bottom of the mud flap at high speeds, or the increased temperature in the area of the tire. Further, when the flexible flaps are opened by a stream of water, substantial quantities of water may pass through the mud flap without deflection.

U.S. Pat. No. 5,366,247 describes a vehicle splashguard having louvers adapted to deflect water and other debris downwardly rather than sidewardly or rearwardly into the path of following traffic. The louvers extend generally horizontally across substantially the entire width of the splashguard. Similarly, U.S. Pat. No. 5,564,750 describes a mud flap having louvers that extend horizontally across substantially the entire width of the mud flap. In addition, the mud flap includes a vertical rib member midway between the ends of each louver to provide vertical support to the louvers. The louvers of these mud flaps, however, do little to reduce the drag forces created by air resistance because the sum of the areas of the openings is small relative to the surface area of the mud flap panel, and the louvers are angled only slightly from the vertical axis. The louvers of these mud flaps are also likely to break or crack with extended use. In addition, the louvers of these mud flaps increase the depth or thickness of the mud flaps, which may not be desirable on certain types of vehicles. Further, the design of these mud flaps is complicated, and the cost of manufacture, maintenance and repair is high.

U.S. Pat. No. 5,273,318 describes a vehicle mudguard having multiple screens and draining ribs. This mud flap, however, does not permit any air to flow through it. U.S. Pat. No. 5,582,430 describes a spray protection device having an inlet layer and a spacer layer which creates a void therebetween. Such screens and layers, however, are typically made from metal which tends to rust with use and increases the weight of the mud flap. In addition, the complex air flow design of the screens and layers tends to become clogged with use.

U.S. Pat. No. 4,964,655 describes a heavy duty mud flap made from metal segments connected by rods which contain a plurality of alternating rubber discs and spacers. This mud flap is also heavy and complex, thereby increasing fuel consumption and manufacturing, maintenance and repair costs.

### SUMMARY OF THE INVENTION

A spray protection device suitable for use on substantially all types of vehicles is provided. The disclosed spray protection device is thin, lightweight, resistant to rust and corrosion, and is capable of deflecting the spray produced behind a traveling vehicle by the wheels traveling on a wet surface. The disclosed spray protection device can be attached in proximity to one or more wheels, such as behind a wheel or beside a wheel towards the outer edge of the vehicle.

In one embodiment, the disclosed spray protection device takes the form of a substantially flat structure with a first side facing the relevant vehicle wheel and a second side facing away from the wheel and comprises a panel adapted to allow air to pass through the spray protection device, while deflecting substantially all of the water and roadway debris it encounters.

The panel has a front face and a top edge, and comprises a plurality of randomly or irregularly spaced and sized openings, apertures, holes, or perforations positioned on the front face. The randomly or irregularly spaced and sized openings preferably have a non-uniform size distribution and are irregular in size, shape, and distribution throughout the panel of the device. The openings permit air to flow through the panel, and are spaced and sized such that the panel deflects substantially all water and roadway debris the panel encounters. The sum of the areas of the plurality of openings represents at least about 50% of the surface area of the front face of the panel. The panel is not likely to become clogged with use and, if necessary, can be easily unclogged and cleaned. The panel may be constructed of any woven fabric, weft-knitted fabric, knitted fabric or fleece, including, but not limited to, woven nylon. In one embodiment, the panel is mesh-like and has a thickness of about ½ inch, with the average area of the opening being about 1/16 square inch (in²). In another embodiment, the panel may be integrally formed with the spraying protection device.

In certain embodiments, the panel comprises a plurality of strands or fibers. The strands may be arranged in an irregular pattern, with almost random arrangement in three dimensions. Alternatively, the strands are arranged in a regular pattern. The plurality of strands define the plurality of irregularly sized and spaced openings adapted to permit air to flow through, and the openings may be formed by the bending of a single strand or intersections of a plurality of strands. The strands may be of any size, and may be a uniform strand type or may have a non-uniform diameter over their length. The strands, which may be constructed of plastic, nylon, synthetic polymer and the like, may be coated with hydrophilic or hydrophobic materials.

The disclosed spray protection device may also be provided with means for attaching the device to a vehicle and is adaptable to any desired type of vehicle. The various elements of the spray protection device may be connected to a vehicle by any known jointing process, such as welding, gluing, connecting by way of mechanical connecting elements, sewing or the like, as well as with or without additional auxilliary materials. The device can also be attached to vehicles by way of attachment or securing elements such as screws, bolts, pins, and the like.

In another embodiment, the spray protection device comprises at least two panels layered on top of each other. This embodiment represents a particularly stable spray protection device, and is suitable for vehicles which are exposed to extreme mechanical loads by heavy dirt or mud, such as construction site vehicles.

In yet a further embodiment, the spray protection device comprises a plurality of panel strips in a vertical orientation, with the panel strips being arranged adjacent to each other. Each panel strip comprises a plurality of randomly or irregularly spaced and sized openings, defined by a plurality of strands as described above.

### BRIEF DESCRIPTION OF THE DRAWINGS

The present invention will be described in greater detail in the following detailed description, with reference to the accompanying drawings, wherein:

FIG. 1 is a front view of an embodiment of the disclosed spray protection device; and

FIG. 2 is a front view of another embodiment of the disclosed spray protection device.

### DETAILED DESCRIPTION OF THE INVENTION

A spray protection device suitable for use on substantially all types of vehicles is provided. The disclosed spray protection device is thin, lightweight, durable, resistant to rust and corrosion, and is capable of deflecting the spray produced behind by the wheels of a vehicle traveling on a wet surface. The disclosed spray protection device can be attached in proximity to one or more wheels of a vehicle, such as behind a wheel or beside a wheel towards an outer edge of the vehicle.

In one embodiment, the disclosed spray protection device takes the form of a substantially flat structure with a first face facing towards the relevant vehicle wheel and a second face facing away from the wheel, and comprises a panel adapted to allow air to pass through the spray protection device while deflecting substantially all of the water and roadway debris it encounters.

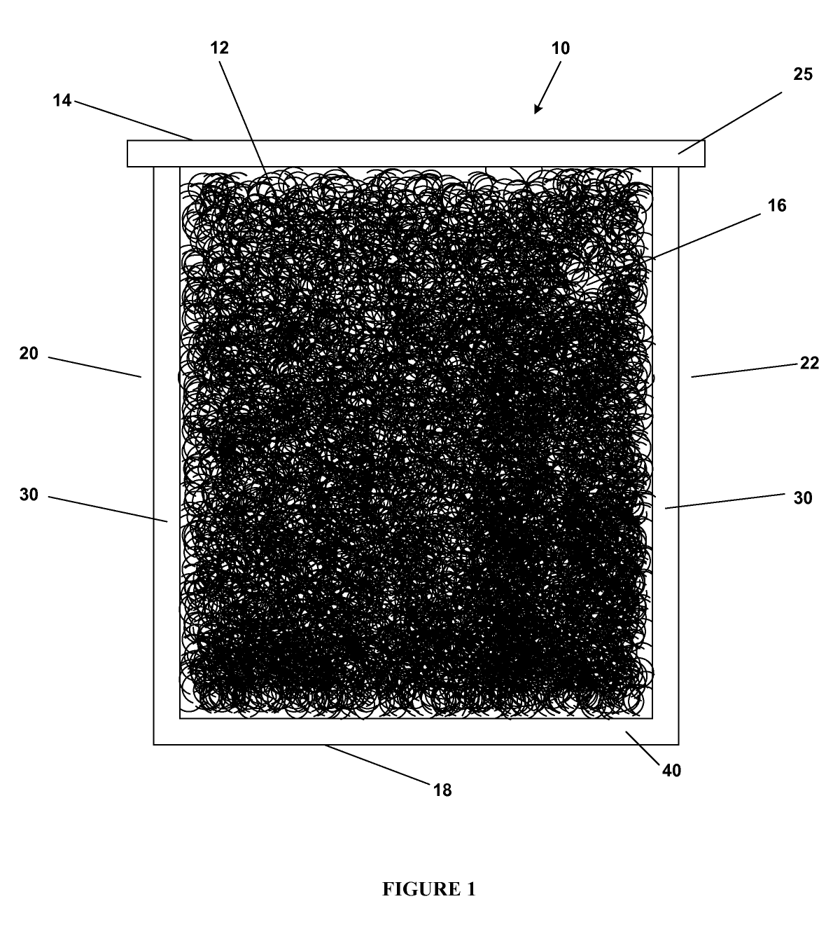

FIG. 1 shows an embodiment of the disclosed spray protection device 10, comprising a panel 12. In the illustrated embodiment, panel 12 is generally rectangular in shape, however those of skill in the art will appreciate that panel 12 may be constructed of any suitable shape for deflecting water and other roadway debris propelled by the tires of a motor vehicle.

Panel 12 comprises a plurality of randomly or irregularly spaced and sized openings, apertures, holes, or perforations 16. Openings 16 have a non-uniform size distribution and are irregular in size, shape and/or distribution throughout the panel 12 of the device 10. The openings 16 are spaced and sized such that the panel 12 deflects substantially all water and substantially all roadway debris the panel 12 encounters while permitting air to flow through device 10.

The surface area of the panel 12 is the area defined by top edge 14, lower edge 18, left edge 20, and right edge 22 of the device 10. In one embodiment, the sum of the areas of openings 16 represents at least 50% of the surface area of the panel 12. In other embodiments, the sum of the areas of openings 16 represents at least 60%, 70% or 80% of the surface area of the panel 12.

In one embodiment, the average area of each of the openings 16 is about 1/16 in². Openings 16 having this dimension permit air to flow through while substantially all water sprayed by the wheel of a vehicle and substantially all roadway debris encountered by the spray prevention device 10 is deflected. The flow of air through such openings 16 results in minimal rearward displacement of the panel 12 when it is attached to a vehicle traveling at high speeds. Openings 16 having this dimension allow some water and roadway debris to move from the front face of the panel 12 to the opposite side of the panel 12, however substantially all of the water and other roadway debris is impeded or obstructed by the panel 12. In other embodiments, the average area of the openings 16 is about 1/24, about 1/12 or about ⅛ in². The panel 12 may also comprise a combination of openings 16 having an average size including, but not limited to, ⅛ in², 1/12 in², 1/16 in², or 1/24 in². In another embodiment, the panel 12 is mesh-like and has a thickness of about ½ inch.

The panel 12 may be constructed of any woven fabric, weft-knitted fabric, knitted fabric, or fleece, including, but not limited to, woven nylon. Any woven nylon known in the art may be employed.

Panel 12 comprises a plurality of strands or fibers, as shown in FIG. 1. In one embodiment, the strands are arranged in an irregular pattern, with almost random arrangement in three dimensions. In another embodiment, the strands are arranged in a regular pattern (not illustrated). The plurality of strands define the plurality of irregularly sized and spaced openings 16 adapted to permit air to flow through and the openings 16 may be formed by the bending of a single strand or intersections of a plurality of strands. The strands may be of any size, and may be a uniform strand type or may have a non-uniform diameter over their length. The strands may be constructed of plastic, nylon, synthetic polymer, and the like, and may be coated with hydrophilic or hydrophobic materials.

The plurality of strands may be horizontally-disposed, vertically-disposed, or diagonally- or angularly-disposed. Each horizontal strand is substantially parallel to top edge 14, and each vertical strand is substantially perpendicular to top edge 14. Panel 12 may also comprise a combination of a plurality of horizontal strands, a plurality of vertical strands, and a plurality of diagonally- or angularly-disposed strands. It is further contemplated that the strands may be arcuate or some other suitable configuration that defines openings 16 adapted to permit air to flow through the panel 12 while the panel 12 deflects substantially all of the water and roadway debris it encounters. The plurality of strands of panel 12 defines the plurality of openings 16. Each opening 16 may be defined by the random combination of a plurality of horizontally disposed strands, a plurality of vertically disposed strands, and a plurality of diagonally- or angularly-disposed strands.

The disclosed spray prevention device 10 may also comprise a connector for attaching the device 10 to a vehicle, such as connecting strip 25. Connecting strip 25 may be attached to the panel 12 near top edge 14, and may be attached to a vehicle behind or to the outside of a wheel of the vehicle, using any suitable means such as threaded fasteners, rivets, adhesives, and the like. While FIG. 1 illustrates connecting strip 25 as the means for attaching the device 10 to a vehicle, it is contemplated that any suitable means for attaching spray prevention device 10 to a vehicle such as threaded fasteners, rivets, adhesives and the like, may be used.

The spray prevention device 10 is adapted to be attached behind a wheel of a vehicle such that it hangs freely from top edge 14, with its longitudinal axis being substantially perpendicular to the roadway surface. A spray prevention device 10 may also be attached to a vehicle on the outside of a wheel to prevent water and debris from being sprayed or propelled from the side of the vehicle.

As shown in FIG. 1, the spray prevention device 10 may be provided with a pair of vertical support members 30 and a horizontal support member 40. The vertical and horizontal support members 30 and 40 are intended to provide structural support to, and improve the deflecting capabilities of, the device 10. While FIG. 1 illustrates two vertical support members 30 and one horizontal support member 40, it is contemplated that one or more vertical support members 30 and more than one horizontal support member 40 may be provided to improve the strength, stability, and deflecting capabilities of the panel 12. It is further contemplated that vertical and horizontal members 30 and 40 may be located between the vertical and horizontal strands, respectively. It is further contemplated that only one supporting member may be employed in the device 10. In this embodiment, the supporting member may be arranged at or near the top edge 14, and may also function as a connector. Thus, in this embodiment the lower edge 18, left edge 20, and right edge 22 of the panel 12 are not provided with supporting members.

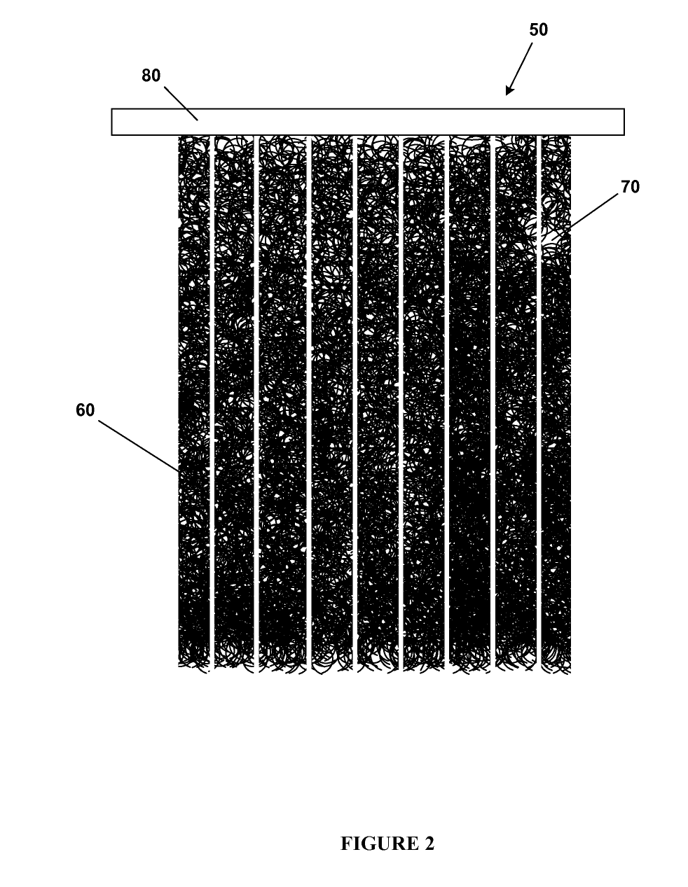

In still another embodiment, as shown in FIG. 2, the disclosed spray protection device 50 comprises a plurality of panel strips 60. In one embodiment, each panel strip 60 measures about 4 to 6 inches in length and about 4 inches to 1 foot in width. Spray protection device 50 comprising the plurality of panel strips 60 may be attached to the side edge of a vehicle above the tire opening to contain the side spray from the roadway. Each panel strip 60 comprises a front face; a top edge; a plurality of irregularly spaced and sized openings 70, wherein each opening 70 has an area of about 1/16 in² and the sum of the areas of the plurality of irregularly spaced and sized openings 70 represents at least about 50% of the surface area of the front face of each panel strip 60.

Each panel strip 60 comprises a plurality of strands or fibers, as shown in FIG. 2.

In one embodiment, the strands are arranged in an irregular pattern, with almost random arrangement in three dimensions. In another embodiment, the strands are arranged in a regular pattern (not illustrated). The plurality of strands of each panel strip 60 define the plurality of irregularly sized and spaced openings 70 adapted to permit air to flow through and the openings may be formed by the bending of a single strand or intersections of a plurality of strands. The strands may be of any size, and may be a uniform strand type or may have a non-uniform diameter over their length. The plurality of strands may be horizontally-disposed, vertically-disposed, or diagonally- or angularly-disposed. Panel strip 60 may also comprise a combination of a plurality of horizontal strands, a plurality of vertical strands, and a plurality of diagonally- or angularly-disposed strands. Each opening 70 may be defined by the random combination of a plurality of horizontally disposed strands, a plurality of vertically disposed strands, and a plurality of diagonally- or angularly-disposed strands. Spray prevention device 50 may also comprise a connector 80 for attaching the device 50 to a vehicle, such as connecting strip.

In operation, the various embodiments of the panel 12 demonstrate the numerous advantages of the invention claimed herein. The relatively large area of the front face of the panel 12 and thus the relatively large number of openings 16 permits a significant amount of air to flow through the panel 12 with minimal rearward displacement of the panel 12. As a result, the panel 12 remains disposed in a position substantially perpendicular to the roadway even when a vehicle is traveling at high speeds. When the panel 12 is disposed in such a position, it is capable of deflecting a greater amount of water and roadway debris away from following traffic. In addition, the increased amount of air flow through the panel 12 reduces the drag forces created by the device 10, thereby increasing a vehicle's fuel efficiency.

The relatively small size of each individual opening 16 in the panel 12 means that substantially all of the water and roadway debris encountered by the panel 12 will be deflected, impeded and/or obstructed by the panel 12. Consequently, the panel 12 will significantly reduce, if not eliminate, the spraying of water and debris into the line of vision of following traffic.

While certain embodiments of the present invention have been described in detail, it will be understood that various changes may be made in the above invention without departing from the scope of the invention. It is intended that all matter contained in the above description or shown in the accompanying drawings shall be interpreted as illustrative and not in a limiting sense.

I claim:

1. A spray prevention device that is attachable in proximity to a wheel of a vehicle, the spray prevention device comprising:
(a) a panel comprising a front face; a top edge; and a plurality of irregularly spaced and sized openings, wherein each opening has an area of about 1/16 in² and the sum of the areas of the plurality of irregularly spaced and sized openings represents at least about 50% of the surface area of the front face; and
(b) a connector for attaching the device to the vehicle.

2. The spray prevention device of claim 1, wherein the irregularly spaced and sized openings are spaced to permit air to flow through the panel while deflecting substantially all water and roadway debris encountered by the panel.

3. The spray prevention device of claim 1, wherein the panel is generally rectangular in shape.

4. The spray prevention device of claim 1, wherein the sum of the areas of the plurality of irregularly spaced and sized openings represents at least about 60% of the surface area of the front face of the panel.

5. The spray prevention device of claim 1, wherein the sum of the areas of the plurality of randomly or irregularly spaced and sized openings represents at least about 70% of the surface area of the front face of the panel.

6. The spray prevention device of claim 1, wherein the sum of the areas of the plurality of randomly or irregularly spaced and sized openings represents at least about 80% of the surface area of the front face of the panel.

7. The spray prevention device of claim 1, wherein each opening of the panel has an area of about 1/24 in².

8. The spray prevention device of claim 1, wherein each opening of the panel has a dimension of about 1/12 in².

9. The spray prevention device of claim 1, wherein each opening of the panel has a dimension of about ⅛ in².

10. The spray prevention device of claim 1, wherein the panel comprises a combination of openings having the average areas of ⅛ in², 1/12 in², 1/16 in² or 1/24 in².

11. The spray prevention device of claim 1, wherein the panel is constructed of a material selected from the group consisting of: woven fabric, weft-knitted fabric, knitted fabric, fleece, and woven nylon.

12. A spray prevention device that is attachable in proximity to a wheel of a vehicle, the spray prevention device comprising:
(a) a panel comprising a front face; a top edge; and a plurality of strands or fibers arranged in an irregular pattern, wherein the plurality of strands or fibers defines a plurality of irregularly sized and spaced openings; and
(b) a connector for attaching the device to the vehicle.

13. The spray prevention device of claim 12, wherein the plurality of strands have a non-uniform diameter over a length of the strands.

14. The spray prevention device of claim 12, wherein each of the plurality of irregularly sized and spaced openings is formed by the bending of a single strand or by intersections of a plurality of strands.

15. The spray prevention device of claim 12, wherein the plurality of strands are constructed of a material selected from the group consisting of: plastic, nylon, and synthetic polymer.

16. The spray prevention device of claim 12, wherein the plurality of strands are coated with a hydrophilic or hydrophobic material.

17. The spray prevention device of claim 12, wherein the plurality of strands is horizontally-disposed, vertically-disposed, or diagonally- or angularly-disposed.

18. The spray prevention device of claim 17, wherein each horizontally-disposed strand is substantially parallel to a top edge of the device, and each vertically-disposed strand is substantially perpendicular to the top edge.

19. The spray prevention device of claim 17, wherein the panel comprises a combination of a plurality of horizontally-disposed strands, a plurality of vertically-disposed strands, and a plurality of diagonally- or angularly-disposed strands.

20. The spray prevention device of claim 12, wherein the panel comprises a plurality of strands or fibers arranged in a regular pattern that define the plurality of irregularly sized and spaced openings and the openings.

21. The spray prevention device of claim 1, wherein the connector is a connecting strip that is attached to the panel near a top edge of the panel and is attachable to a vehicle.

22. The spray prevention device of claim 1, wherein the spray prevention device is adapted to be attached behind a wheel of a vehicle such that it hangs freely from a top edge of the device, with a longitudinal axis being substantially perpendicular to a roadway surface.

23. The spray prevention device of claim 1, wherein the spray prevention device is attached to an outside area of a wheel of a vehicle.

24. The spray prevention device of claim 1, further comprising at least two vertical support members and a horizontal support member.

25. A spray prevention device that is attachable in proximity to a wheel of a vehicle, the spray prevention device comprising:
(a) a plurality of panel strips, wherein each panel strip comprises a front face; a top edge; and a plurality of irregularly spaced and sized openings, wherein each opening has an area of about 1/16 in² and the sum of the areas of the plurality of irregularly spaced and sized openings represents at least about 50% of the surface area of the front face of each panel strip; and
(b) a connector for attaching the device to the vehicle,
wherein spray prevention device is attached to the side edge of a vehicle above a tire opening to contain side spray from the roadway.

26. The spray prevention device of claim 25, wherein each panel stripe measures about 4 to 6 inches in length and about 4 inches to 1 foot in width.
